(19) United States
(12) Patent Application Publication
(10) Pub. No.: US 2025/0365231 A1
(43) Pub. Date: Nov. 27, 2025

(54) SYSTEMS AND METHODS FOR DYNAMIC ROUTING IN NETWORKS

(71) Applicant: MASTERCARD INTERNATIONAL INCORPORATED, PURCHASE, NY (US)

(72) Inventors: Derrick Michael Braga, Rochester Hills, MI (US); Gnanasivam Palaniappan, O'Fallon, MO (US); Sivabalan Mani, Troy, MI (US)

(21) Appl. No.: 18/671,473

(22) Filed: May 22, 2024

(51) Int. Cl. H04L 45/745

(52) U.S. Cl. CPC H04L 45/745

(57) ABSTRACT

Systems and methods are provided for use in dynamically routing messages. One example method includes receiving, by a switch device of a network, a message including an account number indicative of a recipient institution and, in response, identifying a routing table entry for the message based on the account number. The method also includes identifying, by the switch device, a dynamic routing tag in the routing table entry and then, based on the dynamic routing tag, accessing a configuration file including bypass routing instructions for message. The configuration file is separate from the routing table entry. The method then includes routing, by the switch device, the message to the recipient institution consistent with the bypass routing instructions, instead of using routing instructions included in the identified routing table entry.

### FIELD

The present disclosure generally relates to systems and methods for use in facilitating dynamic routing in networks.

### BACKGROUND

This section provides background information related to the present disclosure which is not necessarily prior art.

Routing is known in networks to deliver traffic to the intended recipient. The routing may be based on routing tables, which are coded as routing logic, to define criteria to route traffic to different entities within the networks based thereon. The routing tables are included as routing instructions for switch devices, or other devices, in the networks in receipt of the traffic to be routed.

### BRIEF DESCRIPTION OF DRAWINGS

The drawings described herein are for illustrative purposes only of selected embodiments and not all possible implementations, and are not intended to limit the scope of the present disclosure.

FIG. 1 is a block diagram of an example system of the present disclosure suitable for use in dynamically routing network traffic;

FIG. 2 is a block diagram of an example computing device that may be used in the system of FIG. 1; and

FIG. 3 is an example method, which may be implemented in connection with the system of FIG. 1, for dynamically routing network traffic.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Networks include switch devices, which are programmed to route traffic received by the switch devices, consistent with one or more rules included in routing tables at the switch devices (or available to the switch devices). The rules are generally coded into the switch devices and, conventionally, are static in nature. Uniquely, the systems and methods herein provide a dynamic routing of messages, for example, by the switch devices, based on configuration files called through dynamic (or bypass) routing tags in the routing tables. In this way, additional information associated with the messages and included in the configuration files (which was not previously used/available for routing the messages based on the static rules) is used in dynamically directing the messages by the switches (e.g., whereby the separate configuration files incorporate the dynamic routing capability described herein, etc.).

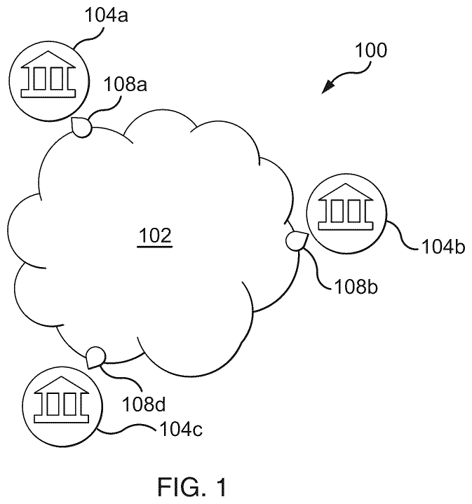

FIG. 1 illustrates an example system 100, in which one or more aspects of the present disclosure may be implemented. Although the system 100 is presented in one arrangement, other embodiments may include the parts of the system 100 (or other parts) arranged otherwise depending on, for example, distribution of processing devices (e.g., switches, etc.), distribution of nodes, services associated with payment accounts and payment account transactions, etc.

As shown in FIG. 1, the system 100 generally includes a network 102 and multiple institutions 104a-c, each coupled to (and in communication with) the network 102. In general, the network 102 may include a payment network and the institutions 104a-c may include banking institutions, which issue accounts to users, merchants, etc. In connection therewith, the accounts may include, for example, credit accounts, savings accounts, prepaid accounts, debit accounts, checking accounts, etc. The accounts are generally identified by primary account numbers or PANs. Often, the account numbers issued by the institution 104a are included in a first range, while the account numbers issued by the institution 104b are included in a second, different range. The ranges may be defined by a different bank identification number or BIN, which is included in the first segment of the PANs. The ranges may be indicative of different institutions, and also different types of accounts for the particular institutions. For example, a range dedicated to the institution 104c may be divided into sub-ranges indicative of card type (e.g., gold card, platinum card, travel card, etc.), or based on region or country of issuance, etc. Consistent with the above, the accounts may be credit accounts, debit accounts, prepaid accounts, etc., and may be used to transfer funds between users, merchants, etc.

In this example embodiment, the institutions 104a-c may be related to one another, as either different locations of the same business or associated through one or more business relationship. For example, institutions 104a and 104c may be separate branches of ACME Bank. And, in another example, institution 104b and institution 104c may be located in different regions, and associated, through a contract, whereby each processes transactions in its respective region for the other institution.

It should be understood that each of the institutions 104a-c is associated with at least one unique identifier, such as, for example, an issuer processor identifier (or ID).

In the illustrated embodiment of FIG. 1, the institutions 104a-c should be understood to be distributed geographically within one or more regions, etc. The regions may include, without limitation, continents, geo-political regions, countries, territories, states, counties, cities, etc. For example, the institution 104a may be located in India, while the institution 104b may be located in the United Kingdom and the institution 104c may be located in India. It should be appreciated that in other system embodiments, additional institutions may be disposed in the same region(s) and/or various different regions.

In this example embodiment, the network 102 includes a payment processing network, which is configured to facilitate and/or coordinate messaging associated with fund transfers and related services. The network 102 may include, for example, the MASTERCARD, VISA, DISCOVER, etc., payment processing network, etc.

As shown in FIG. 1, the network 102 also includes multiple switch devices 108a-c. Each of the switch devices 108a-c is configured to connect with and/or provide communication to different ones of the institutions 104a-c (e.g., where the institutions 104a-c may be acquirers, issuers, etc.). In particular, each of the switch devices 108a-c is coupled to one or more interface processors, which is configured, in turn, to receive messages from the institutions 104a-c and to convert the messages to an internal protocol. The messages may include, for example, authorization messages, etc. The interface processors are then configured to pass the messages to the switch devices 108a-c, which are configured to route the messages internal to the network 102 to reach an appropriate recipient institution(s). It should be appreciated that the interface processors may be included, in whole or in part, in the switch devices 108a-c in other embodiments.

In one example purchase transaction, for example, a user initiates a transaction with a merchant (not shown) to be funded by a payment account issued by the institution 106b (e.g., in Region B (not shown), where institution 104b is located in Region B; etc.) by presenting a corresponding payment device to the merchant (e.g., in Region A (not shown), where institutions 104a, 104c are located in Region A; etc.). In turn, the merchant is configured to read the payment device and to compile an authorization request (broadly, a message) to be provided to the institution 104a (i.e., as an issuer of the merchant's banking account). The institution 104a is configured to submit the message to the network 102, via the switch device 108a.

It should be appreciated that the message in this example is consistent with the ISO 8583 standard, which is an international standard for financial transaction card originated interchange messaging. As such, in this example, the message includes specific data in defined data elements of the message. That said, it should be appreciated that the message may be consistent with another financial messaging standard in other system embodiments (e.g., the ISO 20022 standard, etc.).

In connection with the above, the switch device 108a is configured to determine the routing of the message (e.g., to which recipient institution, etc.) based on a routing table entry included in (or otherwise accessible by) the switch device 108a (e.g., in a routing table stored in memory of the switch device 108a or centrally stored and otherwise accessible by the switch device 108a, etc.) and further based on data included in the message. Conventionally, such routing table entry is imposed in static coded rule(s) included in the switch device 108a (e.g., in the routing table, etc.), whereby the rules rely on the BIN (bank identification number) of the PAN (primary account number) and the message type (e.g., 0100 message type, 0200 message type, etc., included in the ISO 8583 message, etc.), to route the message to the appropriate institution 104b (e.g., as an issuer processor for the transaction, etc.). That is, the routing table entry includes the BIN (or range of bins) and the message type for the message being linked to the unique identifier for the institution 104b. As such, based on the routing table entry, and the BIN and message type, the switch device 108a is configured to route the message to the institution 104b (based on the conventional static routing rules).

It should be appreciated that the routing is substantially the same for different pairs of the institutions 104a-c and other institutions.

That said, this conventional use of static routing rules in the routing table entries provides limited flexibility, as each change to the routing table requires a new routing table entry/rule, which is subject to development, testing and deployment, through one or more processes, prior to being deployed to the switch devices 108a-c. In connection therewith, evolving market needs and increased regulatory restrictions result in increased numbers of updates to the existing static routing rules, such that implementing the updates can be time consuming and disruptive (e.g., resulting in downtime of the switch devices 108a-c, etc.). Further, current authorization routing capability, in which the static routing rules are based on a fixed set of criteria, may not be able to satisfy the increased needs associated with such updates (as well as the demands associated with the evolving market needs and increased regulatory restrictions associated therewith, etc.).

In this example embodiment, however, the routing table entries are adapted to include dynamic routing tags (also termed bypass routing tags herein, etc.) for routing/directing messaging in the system 100. The tags include (or link to or are configured to direct the switch devices 108a-c to, etc.) a set of conditions/criteria associated with the messages, which defines an alternate routing of the messages, or a bypass to the conventional routing (e.g., thereby providing a new and/or modified destination determination for the messages over that provided by the conventional static routing rules, etc.). Presence, or not, of the tags in the routing table entries may be based on details of accounts (e.g., a BIN or BIN range for accounts, etc.), details of transactions (e.g., a merchant or merchant type involved in the transaction, a merchant category code (MCC) for the transaction, etc.), etc. That is, for example, each of the routing table entries may be specific to a particular BIN range, whereby messages for accounts within the BIN range are routed consistent with the corresponding routing table entry, which may then be based on the static rules in the entry (when the tag is not present) or based on dynamic rules associated with the tag (when the tag is present).

In connection therewith, the switch device 108a, for example, upon receiving a message, is configured to identify a routing table entry, in general, or specific to details of the account (e.g., based on the BIN of the account number included in the message, etc.), and to identify whether a dynamic routing tag is present in the entry or not. When present, the switch device 108a is configured to determine a status (or applicability) of the dynamic routing tag included in the entry (e.g., a Y or N indicator within the routing table indicating to apply or not apply dynamic routing, etc.). And, in response to identifying the status of the dynamic routing tag, the switch device 108a is configured to (a) route the message as is conventional using static routing instructions from the identified routing table entry (e.g., where the dynamic routing tag is “N”, etc.) or (b) access a routing configuration record (or file) (e.g., a dynamic transaction-based routing file, etc.) and apply bypass routing instructions from the configuration filed instead of the static routing instructions from the identified routing table entry (e.g., where the dynamic routing tag is “Y”, etc.). In connection with the later, the configuration file is separate from the routing table entry, whereby upon determining that the dynamic routing tag is present and applicable, the switch device 108a is configured to access the separate configuration file for instructions (or directions or rules, etc.) as to routing the message (instead of using the conventional static rules). In particular, the routing configuration file may include additional criteria, not included in the corresponding routing table entry, which may rely on any data, again, included in the authorization message, or not, and/or the designation of the institution to which the message is to be transmitted (e.g., as a basis for use in determining the dynamic routing of the messages, etc.). The data may include, without limitation, a BIN range, a processing code, a currency type, an institution country (e.g., the acquirer, the issuer, etc.), a merchant category code (MCC), or data from other data elements included in the message, etc. Table 1 includes a portion of an example routing table (e.g., an entry associated with the routing table, etc.), illustrating presence (and applicability or enablement) of a dynamic routing tag (e.g., identified as TBR in Table 1).

TABLE 1
Routing Table Entry

| | |
|---|---|
| Institution ID: 00000000 | Institution Name: ABC |
| On Behalf CVC3: 00 | PositiveID: N |
| MBR NBR: | Installment: N |
| OBS2-Decline: N | MCE Pre Auth: N |
| MRCH Gen: N | PIN Verify: N |
| FSA/HRA Cash Back: N | Transaction Based Routing (TBR): Y |
| Token Ind: N | On Us: N |

In this manner, the dynamic routing tag is appended to the routing table entry for the institution 104a, for example, whereby the general (conventional) routing (based on the static rules included in the routing table entry) may be bypassed. In doing so, in some examples, as described above, the switch devices 108a-c may be configured to initially identify presence of the dynamic routing tag in the routing table entry and then, when present, use the dynamic routing criteria associated with (or linked to, etc.) the dynamic routing tag (as included in the separate configuration file) to route messages (e.g., by comparing the dynamic routing criteria included in the configuration file against the content of various fields of the given message, etc.). As such, when the switch devices 108a-c receive messages and determine that dynamic routing should be applied (based on presence of or an indication of the dynamic routing tags in the routing table entries), the switch devices 108a-c are configured to access the appropriate routing table entries consistent with the messages. The entries may in turn include the dynamic routing tag to indicate routing instructions via an associated configuration file (e.g., based on a “Y” tag in the entry, etc.), or routing via conventional instructions (e.g., based on a “N” tag in the entry, etc.). In the instance where the dynamic routing tag is indicative of dynamic routing, the switching devices 108a-c are configured to access (or otherwise receive details from) the separate configuration file and apply the instructions, rules, etc. included therein to route (dynamically) the messages. In this way, the routing table entries provide for dynamic routing and conventional routing going forward whereby limited changes would be required to the routing table entries, generally, for reasons unrelated to dynamic routing.

Consequently, and as discussed above, it should be appreciated that implementing the separate configuration file in the system 100 in this manner provides for improved flexibility, in routing messages, over use of the conventional static rules included in the routing table entries, in that improved ability to update the routing criteria is limited to changes to the configuration file, leaving the routing table entries unchanged. For instance, the static rules conventionally used for routing are included in the routing table entries, whereby significant configuration revision resources (e.g., development, time, testing, release, etc.) are required to apply the updates. That is, updating the static rules typically requires extensive testing/confirming of the changes (to ensure they result in the correct routing) before the routing table updates can be implemented. Such testing/confirming is not required with regard to the configuration file, as it is outside of the existing routing table (and is generally independent of the static rules therein).

In one example, where a regulation requires that certain transactions be maintained in Region A, for example, the dynamic tag may be included in criteria defining a specific country of the acquirer of the transaction and a currency of the transaction. The configuration file may then include a designation of the institution 104c, which is also in Region A, based on an agreement between the institution 104b and the institution 104c for the institution 104c to be the issuer processor for the transaction initiated in Region A in the currency of Region A.

It should be understood that the dynamic routing tag may be based on any data included in the message and or rules associated therewith. In another example, the dynamic routing tag may indicate a particular issuer processor for all transactions having an MCC of a particular type, or may cause all transactions having an MCC of particular type to be blocked. As such, the dynamic routing tag(s) included in the routing table entry for a particular account range and/or message type provides substantial flexibility in routing transactions, within the network 102, without the need for new routing table entries and/or the associated development, testing and implementation, etc.

While only three institutions 104a-c and three switch devices 108a-c are illustrated in FIG. 1 (for ease of illustration), it should be appreciated that the system 100 may include any desired number of such parties and/or devices within the scope of the present disclosure. In general, the system 100 will often include many more of each of these parties and/or devices.

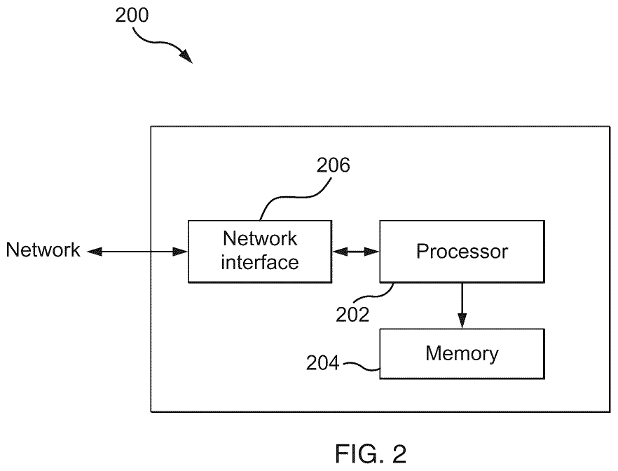

FIG. 2 illustrates an example computing device 200 that can be used in the system 100. The computing device 200 may include, for example, one or more servers, workstations, computers, laptops, point-of-sale (POS) devices, etc. In addition, the computing device 200 may include a single computing device, or it may include multiple computing devices located in close proximity or distributed over a geographic region, so long as the computing devices are configured to function as described herein. In the system 100, each of the institutions 104a-c, and each of the switch devices 108a-c may include, or may be implemented in, a computing device consistent with computing device 200. In connection therewith, each is then coupled to, and is in communication with, one or more networks interconnecting these parts of the system 100. However, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a programmable gate array (e.g., a field programmable gate array (FPGA), etc.), a system on chip (SOC), and/or any other circuit or processor capable of the operations described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, operational data, statistical data, analytical data, performance data, dynamic routing tags, and/or other types of data (and/or data structures) suitable for use as described herein. Furthermore, in various embodiments, computer-executable instructions, i.e., software instructions, may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 that is performing one or more of the various operations herein (e.g., one or more of the operations of method 300, etc.). In addition, one or more load files may be stored in memory 204, which include hardware descriptions that, when loaded to the processor 202 (or another processor), cause the processor 202 to be structured consistent with the descriptions herein (e.g., descriptions of gate array arrangements/configurations, etc.).

Further, the illustrated computing device 200 also includes a network interface 206 coupled to (and in communication with) the processor 202 (and/or the memory 204) and configured to provide communication and/or coupling to one or more networks. The one or more networks may include, without limitation, one or more of a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. Consistently, the network interface 206 may include, without limitation, a wired network adapter, a wireless network adapter, a mobile network adapter, or other device capable of communicating to/with the one or more different networks, for example, as included in the system 100. In some example embodiments, the computing device 200 includes the processor 202 and one or more network interfaces 206 incorporated into or with the processor 202.

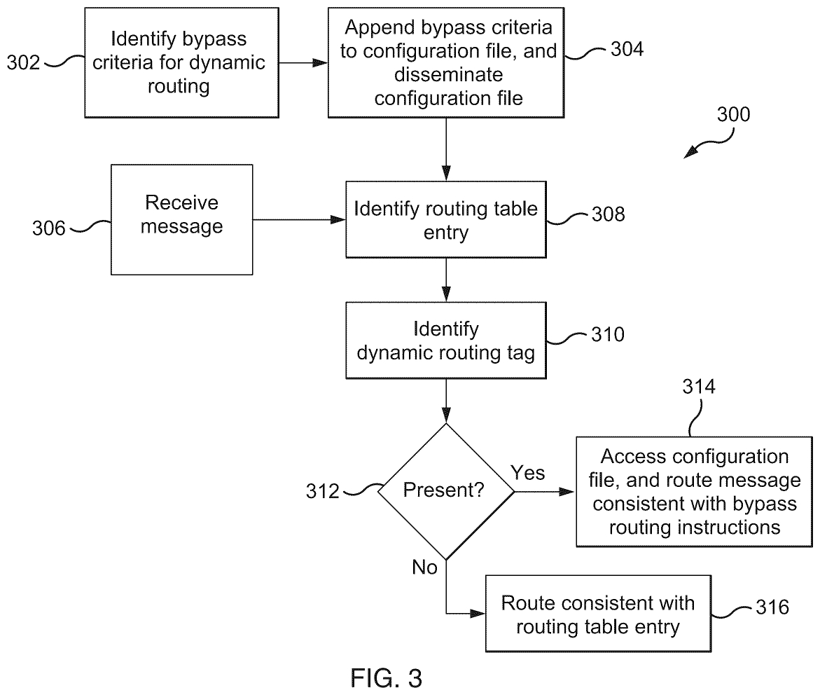

FIG. 3 illustrates an example method 300 for use in dynamically routing of network traffic. The method 300 is described with reference to the system 100, and in particular, the switch devices 108a-c, and also with reference to the computing device 200. While described in this manner, however, it should be appreciated that the methods herein are not limited to the system 100 and/or the computing device 200. Likewise, it should also be appreciated that the systems and methods herein should not be understood to be limited to the method 300.

Consistent with the above, the switch devices 108a-c include a routing table, which includes routing table entries. The routing table entries are defined by BIN, or BIN range, and/or message type. In connection therewith, in some examples, the routing table may be pushed to each of the switch devices 108a by the network 102 (e.g., at regular or irregular intervals, in response to particular activities such as updates to the routing table and/or entries in the routing table, etc.) (e.g., via a central switch management system of the network 102, etc.). Alternatively, the switch devices 108a may pull the routing tables from the network 102, etc.

That said, in response to a regulatory change, or other condition, it may be determined that a change in routing of messaging from the institution 104a, for example, is required. The change, for example, may be related to regulatory requirements for on-soil processing, or limitation of the exchange of personal identifying information, etc. Uniquely in the method 300, the change(s) is/are implemented by way of updating a dynamic routing configuration file associated with routing messages in the system 100 (and, again, which is separate from the routing table), instead of updating entries in the routing table included at the switch devices 108a-c.

As such, at 302 in the method, the network 102 identifies the criteria (or updated criteria) for the bypass (or dynamic) routing tag(s) (e.g., in response to the regulatory change or other condition, etc.) in one or more entries of the routing table. The criteria may include a condition on the data to be included in a message received by the network 102. For example, the criteria may be based on a currency code, an MCC (or range of MCCs), a region of origin (e.g., based on acquirer identifier, etc.), a region of destination (e.g., based on an issuer identifier or BIN, etc.), a message type, a time of day, a day of the week, an indication of the acquiring processor, a merchant category code (MCC), a POS entry mode, an acquiring country/state, etc. In addition to the criteria, the network 102 also identifies the action to be taken based on the criteria. Example actions include routing to an alternative issuer processor, halting the transaction, implementing a different authorization mode (e.g., an authorization only mode, or an authorization plus reconciliation and settlement mode, etc.).

Thereafter, at 304, the network 102 appends the bypass criteria (e.g., including any needed updated routing criteria, etc.) to the configuration file. In doing so, as described, the bypass criteria may be linked to a routing table entry of the routing table included at the switch devices 108a-c by way of BIN, BIN range, and/or message type, etc. The network 102 then disseminates the configuration file (e.g., as updated, etc.) to the switches 108a-c, for example, as part of the routing table or apart therefrom (e.g., as a push action to the switches 108a-c, as a pull action by the switches 108a-c, etc.) Alternatively, the network 102 may maintain the configuration file in central storage and apply any updates to the switches 108a-c, as needed, in connection with a reload operation, etc.

Thereafter, at 306, the switch device 108a receives a message from the institution 104a. The message is consistent with the ISO standard and includes data indicative of an authorization request for a transaction between a source account and a destination account. The data includes, for example, the message type, an amount of the transaction, a currency code, an account number for the source account, an account number for the destination account, an acquirer ID, a MCC, a time stamp, etc.

In response to the message, the switch device 108a identifies, at 308, the routing table entry for the transaction, based on the account number of the source account and/or the message type. Next, at 310, the switch device 108a looks at the identified entry for one or more dynamic routing tags and, at 312, determines if such tag(s) is/are present.

When a dynamic routing tag is identified/present, the switch device 108a accesses the configuration file, at 314, and applies the bypass routing instructions included in the configuration file to the transaction (e.g., to data included in the authorization request message, etc.) (instead of applying the static routing instructions/rules from the identified routing table entry). For example, the instructions may require transactions between two institutions in Region A, in the currency of Region A, to be processed within Region A, whereby the instructions are based on the BIN of the account numbers and the currency code. And, based on application of the bypass routing instructions (included in the configuration file), the switch device 108a then routes the message as appropriate. In the above example, the switch device 108a may route the message to the institution 104c in Region A, where the institution 104b is contracted with the institution 104c to process transactions directed to the institution 104b in Region A. As such, the configuration file includes the unique identifier of the institution 104c as the issuer processor.

Conversely, when the one or more dynamic routing tags are not present in the identified routing table entry, the switch device 108a routes, at 316, the message consistent with the general instruction included in the routing table entry (in a conventional manner).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code and/or load files (prior to implementation in hardware) in the form of instructions or data structures and that can be accessed by a processor, and/or implemented in hardware. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing one or more of: (a) receiving a message including an account number indicative of a recipient institution; (b) identifying a routing table entry for the message, based on the account number included in the message; (c) identifying a dynamic routing tag in the routing table entry; (d) based on the dynamic routing tag, accessing a configuration file including bypass routing instructions for message, wherein the configuration file is separate from the routing table entry; and/or (e) routing the message to the recipient institution consistent with the bypass routing instructions, instead of using routing instructions included in the identified routing table entry.

As will also be appreciated based on the foregoing specification, the above-described embodiments of the disclosure may be implemented using computer programming or engineering techniques including computer software, firmware, hardware or any combination or subset thereof, wherein the technical effect may be achieved by performing one or more of: (a).

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A network for use in dynamically routing messages, the network including:
a computing device including a processor and a memory, which includes executable instructions that, when executed by the processor, cause the processor to:
receive, from a first institution, a message including an account number indicative of a second institution;
identify a routing table entry for the message, based on the account number included in the message;
identify a dynamic routing tag in the routing table entry; and
route the message to a third institution consistent with the dynamic routing tag.

2. The network of claim 1, wherein the routing table entry includes an instruction to route the message to the second institution.

3. The network of claim 1, wherein the message includes a message type; and
wherein the executable instructions, when executed by the processor, cause the processor to identify the routing table entry further based on the message type.

4. The network of claim 1, wherein the dynamic routing tag is associated with a configuration file, which is separate from the routing table entry, the configuration file including one or more criteria for routing the message; and
wherein the one or more criteria is/are based on data included in the message.

5. The network of claim 4, wherein the data included in the message includes a currency code, a bank identification number (BIN) of the account number, and/or a merchant category code (MCC).

6. The network of claim 4, wherein the configuration file includes a unique identifier of the third institution; and
wherein the executable instructions, when executed by the processor, cause the processor to route the message to the third institution based on the unique identifier of the third institution included in the configuration file.

7. The network of claim 1, wherein the executable instructions, when executed by the processor, cause the processor to:
identify bypass criteria for dynamic routing of the message; and
in response to identifying the dynamic routing of the message, append the bypass criteria to a configuration file associated with the dynamic routing tag and stored in the memory, wherein the configuration file is separate from the routing table entry.

8. The network of claim 1, wherein the executable instructions, when executed by the processor, cause the processor to receive the message from the first institution, through an interface processor.

9. A non-transitory computer-readable storage medium including executable instructions for dynamically routing messages, which when executed by at least one processor, cause the at least one processor to:
receive a message including an account number indicative of a recipient institution;
identify a routing table entry for the message, based on the account number included in the message;
identify a dynamic routing tag in the routing table entry;
based on the dynamic routing tag, access a configuration file including bypass routing instructions for message, wherein the configuration file is separate from the routing table entry; and
route the message to the recipient institution consistent with the bypass routing instructions, instead of using routing instructions included in the identified routing table entry.

10. The non-transitory computer-readable storage medium of claim 9, wherein the message includes a message type; and
wherein the executable instructions, when executed by the at least one processor, cause the at least one processor to identify the routing table entry further based on the message type.

11. The non-transitory computer-readable storage medium of claim 9, wherein the configuration file includes a unique identifier of the recipient institution; and
wherein the executable instructions, when executed by the processor, cause the processor to route the message to the third institution based on the unique identifier of the recipient institution included in the configuration file.

12. The non-transitory computer-readable storage medium of claim 9, wherein the executable instructions, when executed by the at least one processor, cause the at least one processor to:
prior to receipt of the message, identify bypass criteria for dynamic routing of the message; and
append the bypass criteria to the configuration file.

13. The non-transitory computer-readable storage medium of claim 12, wherein the executable instructions, when executed by the at least one processor, cause the at least one processor to route the message to the recipient institution based on the bypass criteria included in the configuration file.

14. The non-transitory computer-readable storage medium of claim 13, wherein the bypass criteria includes a currency code, a bank identification number (BIN) of the account number, and/or a merchant category code (MCC).

15. A computer-implemented method for dynamically routing messages in a network, the method comprising:
receiving, by a switch device of the network, a message including an account number indicative of a recipient institution;
identifying, by the switch device, a routing table entry for the message, based on the account number included in the message;
identifying, by the switch device, a dynamic routing tag in the routing table entry;
based on the dynamic routing tag, accessing, by the switch device, a configuration file including bypass routing instructions for message, wherein the configuration file is separate from the routing table entry; and
routing, by the switch device, the message to the recipient institution consistent with the bypass routing instructions, instead of using routing instructions included in the identified routing table entry.

16. The computer-implemented method of claim 15, further comprising:
generating the configuration file to include bypass criteria for dynamic routing of messages by the switch device; and
disseminating the configuration file to the switch device.

17. The computer-implemented method of claim 16, further comprising routing the message to the recipient institution based on the bypass criteria included in the configuration file.
